(19) United States
(12) Patent Application Publication
(10) Pub. No.: US 2011/0154216 A1
(43) Pub. Date: Jun. 23, 2011

(54) GUI CUSTOMIZING METHOD, SYSTEM AND PROGRAM

(75) Inventors: Toshiyuki ARITSUKA, Kodaira (JP); Tomohiro NAKAMURA, Hachioji (JP)

(73) Assignee: HITACHI, LTD., Tokyo (JP)

(21) Appl. No.: 12/968,476

(22) Filed: Dec. 15, 2010

(30) Foreign Application Priority Data
Dec. 18, 2009 (JP) 2009-287503

(51) Int. Cl. G06F 3/00

(52) U.S. Cl. 715/745

(57) ABSTRACT

A processor executes different types of programs in the memory. Namely, the processor customizes the user's GUI by utilizing a processing unit to judge the user's skill level based on the quality of task results and task time, a processing unit to extract the GUI usage status based on the GUI operating history of the user, a category sorter unit to sort the users into the multiple categories according to the task content and skill level of the user, a processing unit to perform clustering the user group based on the usage status for each sorted category, and a processing unit to customize the GUI based on the usage status in each cluster grouped by a clustering method, and sorts the user for GUI customizing into one of clusters and customizes the user's GUI by applying the GUI customizing method set for that corresponding cluster.

### CLAIM OF PRIORITY

The present application claims priority from Japanese patent application JP 2009-287503 filed on Dec. 18, 2009, the content of which is hereby incorporated by reference into this application.

### FIELD OF THE INVENTION

The present invention relates to a GUI (Graphical User Interface) technology for application software operating on an information processing system, and relates in particular to technology for customizing a GUI according to the usage status and skill level of the user.

### BACKGROUND OF THE INVENTION

The increasingly high performance of computers in recent years has led to more sophisticated and more complex processing of application software operating on computers. Operation by way of the GUI is in fact the main way to interactively operate application software to perform specific required processing tasks. The GUI is a user interface for using a mouse or other tool to directly operate an image object such as a menu or icon shown on the screen. Utilizing a GUI allows even inexperienced users of that application software to predict the operating method to a certain extent based on the GUI object positions and shapes, and similarities to other applications.

However efficiently running all the special operations and commands for the application software functions, requires mastering the operating methods based on experience and education. Operators need a long learning period for application software whose operation is complicated and tasks requiring special knowledge.

Software tools such as CAD (Computer Aided Design) utilized in fields such as semiconductor integrated circuits, construction and mechanical design are application software focusing on tasks in extremely specialized fields. CAD includes a full range of functions spanning numerous operation items for covering diverse design areas and setting target conditions. Operating the application software to execute this type of complicated processing requires accumulated operating skills and wide-ranging knowledge of the target field. This level of skill and knowledge is a large handicap for beginners.

However, not all the application software functions need be used if the target tasks and target conditions are limited. In such circumstances, users with low skill levels encounter the problem of low task efficiency due to confusion in selecting the functions to use during operation or mistakenly calling up a function not related to the task goal. Moreover, users utilize different operating methods. Low skill level users for example mainly call up a function by selecting an object with a mouse, while high skill level users mainly call up functions by using key binds (functions assigned to selected keys).

When the objective in using application software is to obtain task results at a specified quality, an effective approach for obtaining the desired quality in as short a time as possible, is to provide a method that efficiently operates the application software according to the task skill level of the user.

The technology in JP-A-2003-177854 and JP-A-Hei11 (1999)-39127 discloses methods for judging the proficiency level of the user operating the application software by analyzing user operations such as key press speed, mouse operating speed, frequency of user function selection, and then based on that judgment, specifying a GUI already prepared for each proficiency level.

The technology in JP-A 2008-97466 discloses a method for judging user operating features such as the frequency of user function selection and user confusion and then customizing the GUI based on that judgment.

The technology in JP-A-Hei8 (1996)-292864 discloses a method for establishing rules for trends in customizing a GUI for application software already utilized by the user, and then customizing a GUI based on the established rules when the user is using new application software.

Methods for judging the task skill level of the user performing tasks that utilize the target application software include for example JP-A 2004-110333 which discloses a method for judging user's design technology when designing LSI using design tools by evaluating user replies to test design problems (number of gates, timing violations, timing convergence, operating frequency, power consumption, reply time) on replies to test design problems that evaluate user's design technology when designing LSI using design tools.

### SUMMARY OF THE INVENTION

The methods disclosed in JP-A-2003-177854 and JP-A-Hei11 (1999)-39127 linked the user GUI operating status according to a pre-established proficiency level for application software operation. However these methods had the problem that no method was described that linked task efficiency (task quality and time required for the task) when using application software to the proficiency level when operating the application software (first issue).

The technology in both patent documents utilized pre-established customizing settings for each proficiency level to customize the GUI but disclosed no method for establishing customized settings linked to the operating status of each user GUI object. These methods therefore had the problem that they were incapable of finely customizing GUI objects according to proficiency levels (second issue).

The technology in JP-A 2008-97466 and JP-A-Hei8 (1996)-292864 both customized the GUI according to customizing trends and operating trends of the actual user but had the problem that they were incapable of making customizing settings based on objective standards (third issue).

All of the above technology of the related art customized the GUI based on the user's GUI operating status and did not customize the GUI based on user skill levels or task contents when using the application software.

The method in JP-A 2004-110333 judged the user's skill level based on the quality (verified results) from test problem design results (circuit designs, layout, etc.) and task time but did not assume use of those results in improving tool operability so this method had the problem that there was no technique for quantizing proficiency levels by using multiple evaluation standards (fourth issue).

In view of the problems with the related art, this invention has the object of providing a GUI customizing method, system and program, in an information processing system capable of resolving the above issues.

In order to achieve the above objects, this invention is a GUI customizing method, information processing system, and program for customizing the GUI of an information processing system including a processing unit to execute software containing the GUI, and in which the processing unit extracts the usage status of the user from the software operating history, clusters the multiple software users based on the degree of similarity in usage status, changes the software GUI based on the usage status representing each of multiple clusters in which the users were grouped based on clustering results, and groups the specified users into any of the multiple clusters by comparing the usage status of the specified user with the usage status representing each cluster, and customizes the software GUI of the specified user based on the GUI of the cluster in which the specified user was grouped.

In order to achieve the above objects, this invention is a GUI customizing method, information processing system, and program for customizing the GUI of an information processing system including a processing unit to execute software containing the GUI, and in which the processing unit groups the multiple software users into multiple categories based on user skill levels when performing tasks utilizing the applicable software, and into multiple task categories grouped according to the attributes of task objects for tasks utilizing the software, and adjusts the software GUI to match each of the multiple grouped categories and, customizes the user GUI grouped into each of the multiple categories.

Namely, in order to resolve the first and the fourth issues, the preferred aspect of this invention compares the task result quality (performance value) and task target values (limiting conditions) according to task content, and calculates the required time (time required for the task) to find the task efficiency using application software; calculates the required time (time required for the task), and based on those results, customizes the GUI according to the judged skill level of the user.

In order to resolve the second issue, the preferred aspect of this invention extracts the usage status (in what way, what GUI object is being used by which user) of the multiple user groups using the application software according to the skill level of the user, and sets the customizing settings for each GUI object from the usage status.

In order to resolve the third issue, the preferred aspect of this invention sets the user GUI customizing settings based on the usage status of the user group in order of high skill level.

Amore specific aspect includes a method for judging the skill level of the user based on the task time and quality of the task result; includes a method for grouping the application software user group into multiple categories according to the skill level and task content; includes a method for accumulating the GUI operating history of the user, analyzing the operating trends based on the accumulated operating history and extracting the GUI usage status; includes a method for clustering the target application software user group into each category based on the usage status; includes a method to set the GUI customizing method based on the usage status per each cluster based on the clustering method; and includes a method for sorting the users for GUI customizing by clustering into one cluster based on the above clustering method based on the degree of similarity in usage status, and customizing the user GUI by applying the GUI customizing method that was set for each cluster.

The customizing method of this invention improves the task efficiency when using application software by optimal customizing of the application software GUI running on the information processing device such as a computer according to the user task skill level.

The present invention customizes the GUI by utilizing user task results from using the application software, the task time, and the operating history of the application software GUI without requiring internal information from the application software. This invention moreover does not require modifying the application software. The method of the present invention can therefore be used with multiple application software, and can easily be applied when changes were made such as by upgrading the application software version.

### BRIEF DESCRIPTION OF THE DRAWINGS

FIG. 1 is a block diagram of the information processing device shown as one example of the system structure of a first embodiment;

FIG. 2 is a drawing showing the processing flow of the GUI customizing program of the first embodiment;

FIG. 3 is a drawing showing an example of sorting of task contents in the first embodiment;

FIG. 4 is a drawing showing the structure of the user task skill level judgment processing unit in the first embodiment;

FIG. 5 is a table showing one example of performance verification results of the first embodiment;

FIG. 6 is a table showing one example of task conditions during circuit design using the circuit drawing tool of the first embodiment;

FIG. 7 is a table showing one example of skill level judgment conditions in the first embodiment;

FIG. 8 is a diagram showing the process flow during judgment of skill level in the first embodiment;

FIG. 9 is a drawing showing one example of the GUI screen for the application software of the first embodiment;

FIG. 10 is a block diagram showing the structure of the GUI usage status extraction processing unit of the first embodiment;

FIG. 11 is a drawing showing one example of usage status for user i, task category j in the first embodiment;

FIG. 12 is a drawing showing another example of usage status in the first embodiment;

FIG. 13 is a drawing for describing the processing by the user category sorter unit in the first embodiment;

FIG. 14 is a drawing for describing the processing by the user clustering processing unit in the first embodiment;

FIG. 15 is a drawing for describing the processing by the clustering unit in the first embodiment;

FIG. 16 is a drawing for describing the processing by the similarity judgment processing unit in the first embodiment;

FIG. 17 is a drawing for describing the processing by the GUI customizing method setter unit of the first embodiment;

FIG. 18 is a usage status list for the user group belonging to cluster i in the first embodiment;

FIG. 19 is a table showing results from calculating the usage status of the cluster i in the first embodiment;

FIG. 20 is a table showing an example of setting the GUI customizing method in the first embodiment;

FIG. 21 is a diagram for describing the processing by the GUI customizing processing unit in the first embodiment;

FIG. 22 is a diagram for describing the process for displaying and controlling the GUI by the information processing device of the first embodiment;

FIG. 23 is a diagram for describing the method for customizing the GUI of the application software of the first embodiment;

FIG. 24 is a diagram for describing the structure of the GUI customizing unit of the first embodiment;

FIG. 25 is a diagram showing an example of the GUI customizing method in the server-client information processing device of the first embodiment; and

FIG. 26 is a diagram showing another example of the GUI customizing method in the server-client information processing device of the first embodiment.

### DETAILED DESCRIPTION OF THE PREFERRED EMBODIMENTS

The preferred embodiments of this invention are described next while referring to the drawings. In the following description, “skill level” is the level of the user and/or operator who is judged based on the quality (performance value) of the task result and the required time (time required for the task). The respective programs or their functions executed by the information processing device are respectively named the processing, method, or processing unit. One should be aware that the “skill level judgment program” is for example sometimes called “skill level judgment processing”, “skill level judgment method”, or “skill level judgment processing unit.”

### First Embodiment

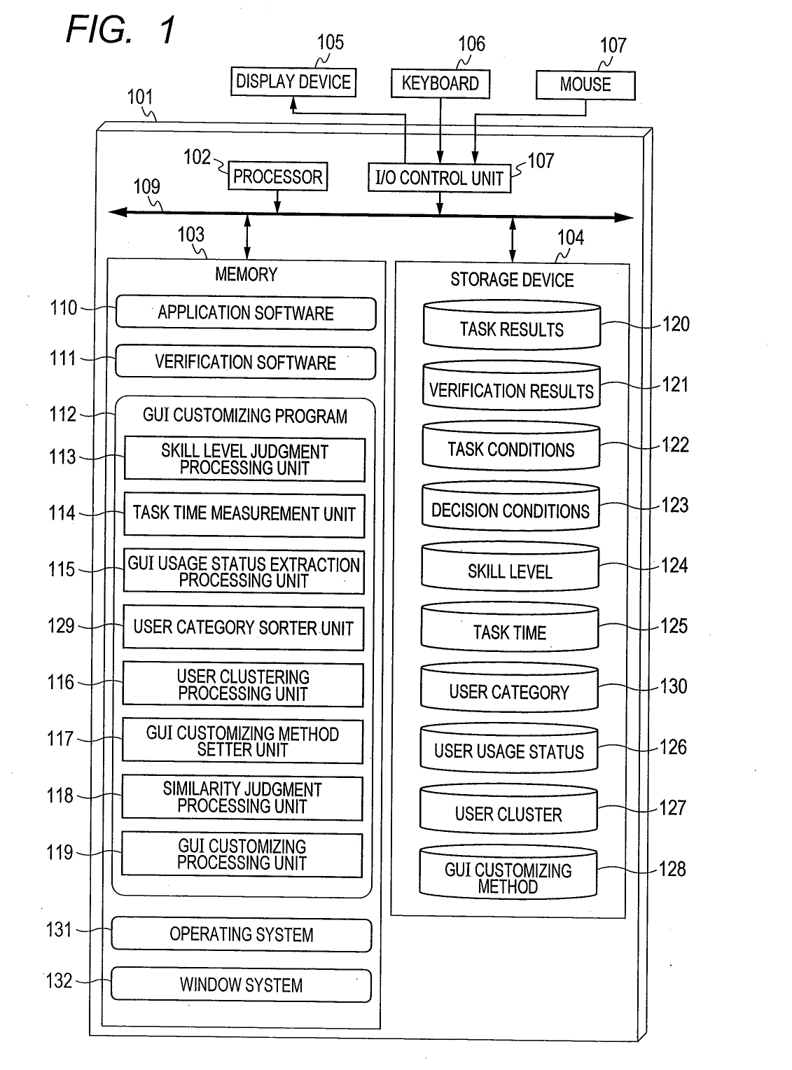

FIG. 1 is a block diagram showing an example of the system structure implemented on an information processing device such as a computer in the first embodiment.

In FIG. 1, the reference numeral 101 denotes a computer system such as a EWS (Engineering Workstation) or PC (personal computer) or server device, etc. The computer system 101 contains at least a processor 102 as a processing unit for performing various calculations; a memory 103 for storing images and data for executing all types of software such as operating systems as software to control the computer, a window system for controlling the GUI, and application software; a storage device 104 such as a hard disk for storing software files and data; a display device 105 as a user interface; and an input/output control unit (I/O: Input/Output 108) that connects to and controls the keyboard 106, and mouse 107, communication is carried out along the bus 109. The memory 103 and the storage device 104 are the storage unit for the computer system.

The storage device 104 retains the software and data for the operating system and application as stored files even if the power to the computer system is cut off, and loads that data into the memory 103 when the computer system operates. In this embodiment, these operations are the same as in a typical computer system but are not shown in the drawing because the operations do not appear in the description of the embodiment. Moreover, the computer system 101 contains other software and hardware required for normal operation of a computer system such as EWS, PC and server devices but this software and hardware is not utilized in the description of the embodiment and so does not appear in the drawings.

The memory 103 contains at least the software 110 as the object for applying the GUI customizing method of this embodiment; verification software 111 as an example of a technique for verifying results of user operation using application software; and images for the GUI customizing program 112 for executing the GUI customizing of this embodiment. The memory 103 also stores the operation system 131 and the window system 132.

The GUI customizing program 112 contains a skill level judgment processing unit 113 for judging the task skill level of the user of the application software 110; a task time measurement unit 114 to measure the task time; a GUI usage status extraction processing unit 115 to extract the GUI usage status of the application software; a user category sorter unit 129 to group the users into multiple categories; a user clustering processing unit 116 to cluster the users according to the usage status; a GUI customizing method setter unit 117 to set the GUI customizing method for the application software 110; a similarity judgment processing unit 118 to judge the degree of similarity between the GUI usage status of the user cluster, and the user for whom the GUI is being customized; and a GUI customizing processing unit 119 for executing the GUI customizing.

The storage device 104 stores at least a task result 120 utilizing the application software 110, a result 121 which verified the task results with verification software, a task condition 122 for task performance goals and limiters, etc, a judgment condition 123 for use when judging skill levels of the application software 110 user from the verification results 121, a user skill level 124 that is judged based on the judgment condition 123, a task time 125 required for the task utilizing the application software 110, a user category 130 which is the user grouping results, a user GUI usage status 126, a user cluster 127 which is the user clustering results, and a GUI customizing method 128. The above components generate, update, and load the memory according to the operation of the GUI customizing program 112.

The processor 102 contains at least a CPU (Central Processing Unit). The processor 102 accesses the memory 103 and runs the application software 110, the verification software 111, and the GUI customizing program 112 by way of control software such as an operation system. The processor 102 renders a display on the display device 105 such as an image or character display monitor by way of the I/O control unit 108, and acquires information that the user input by using an input device such as a keyboard 106 or a mouse 107 according to the software.

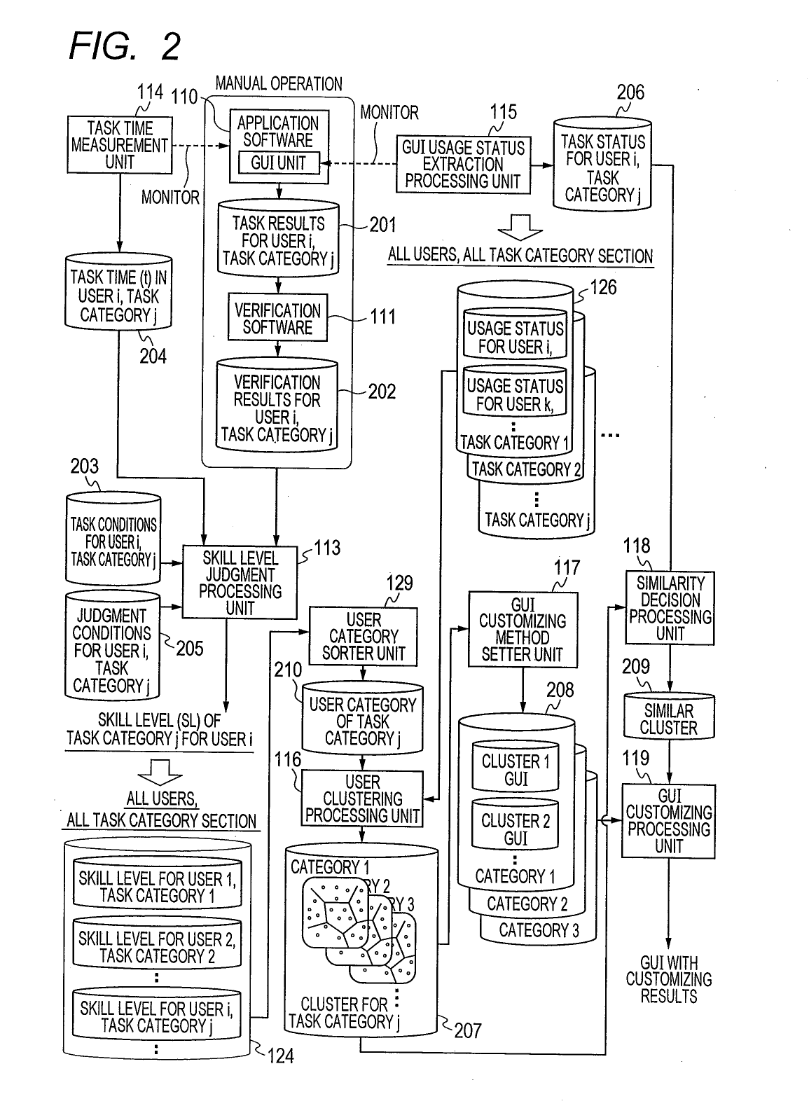

FIG. 2 is a diagram showing the processing flow by the GUI customizing program 112 in FIG. 1. The reference numeral 110 in the figure denotes the application software for applying the GUI customizing method of this embodiment. Interactively operating this software by way of the GUI outputs the task results 201 which are results from a certain user i performing a certain task category j. Here, a task category is the grouping of all tasks utilizing this application software based on attributes of the task object such as the type of task content and object of that task.

The verification software 111 is one technique utilized for verifying the task result 201 performance. The verification software 111 verifies the quality and performance of the task result 201, and outputs the verification result 202. The task result 120 and verification result 121 in FIG. 1 are equivalent to accumulated data used in this embodiment from among task results and verification results of other uses of this application software.

The skill level judgment processing unit 113 judges the skill level for user i, task category j by using the verification result 202 of the user i in the task category j; the task time measured by the time task measurement unit 114 by monitoring the application software start-up and task result output, the task conditions 204 as target values and limiting conditions for operation, and the skill level judgment conditions 205. This processing is performed in this embodiment for all users and task categories and the skill level 124 is then found.

The GUI usage status extraction processing unit 115 acquires the status of the application software 110 whose GUI was operated by the user by monitoring the GUI information in application software 110, and extracts the usage status by analyzing this information. The reference numeral 206 is results from extracting the GUI usage status for user i, task category j. The usage status is extracted for all users and task categories when implementing this embodiment and is found as the usage status 126.

The user category sorter unit 129 groups the users who performed each task category into multiple categories based on the skill level 124 for all users and task categories. In FIG. 2, the user category 210 is shown only as results from grouping the task category j in order to simplify the description. Actually, all the task categories are objects for processing. The user category 210 in FIG. 2 stores a list of categories for grouping the user group that performed the task in task category j based on their skill level, and a list of groups belonging to each category. In other words, the categories where the users are grouped are established based on multiple task categories according to attributes of the task object, and the multiple skill levels for each task category.

The user clustering processing unit 116 clusters the user groups belonging to each category of user category 210 based on the degree of similarity of each user usage state stored in user usage status 126. In FIG. 2, the results from clustering of task category j were shown as the clustering results 207 to simplify the description but the actual clustering process is applied to all task categories.

The GUI customizing method setter unit 117 finds the representative usage status for each cluster from the clustering results 207 and sets that usage status into the GUI customizing method 128 in storage device 104, as the GUI customizing method 208 corresponding to each category. The GUI customizing processing unit 119 decides the GUI customizing method 211 when the user i is performing a task in task category j as described later on, and customizes the GUI based on this method 211. Here, only the same indices i and j are used to simply the figures shown for this invention but in the actual processing a new user different from the user clustering object used here may be the object for GUI customizing. The processing in that case is carried out from the user clustering process onwards, for the user category of the task category associate with the new user.

The similarity judgment processing unit 118 judges the degree of similarity between the usage status for user i, task category j and representative points in each cluster of clustering results 207. Based on this judgment the unit 118 decides to which cluster the user i belongs and sets the similar cluster 209. A limiting condition can be set at this time in which those users who are objects for GUI customizing and clusters that are objects for degree of similarity judgment, are placed in different categories. The rules in that case can be set to link users who are objects for GUI customizing, with categories in which clusters for degree of similarity judgment belong to, for example by selecting a category with a skill level higher than the user skill level such as a category having a skill level at least one stage higher than the user skill level.

The GUI customizing processing unit 119 selects a GUI customizing method corresponding to the similar cluster 209 from 211, and customizes the GUI based on this method. The unit 119 in other words, performs processing such as adjusting, changing, setting, or generating the GUI and then outputs those results.

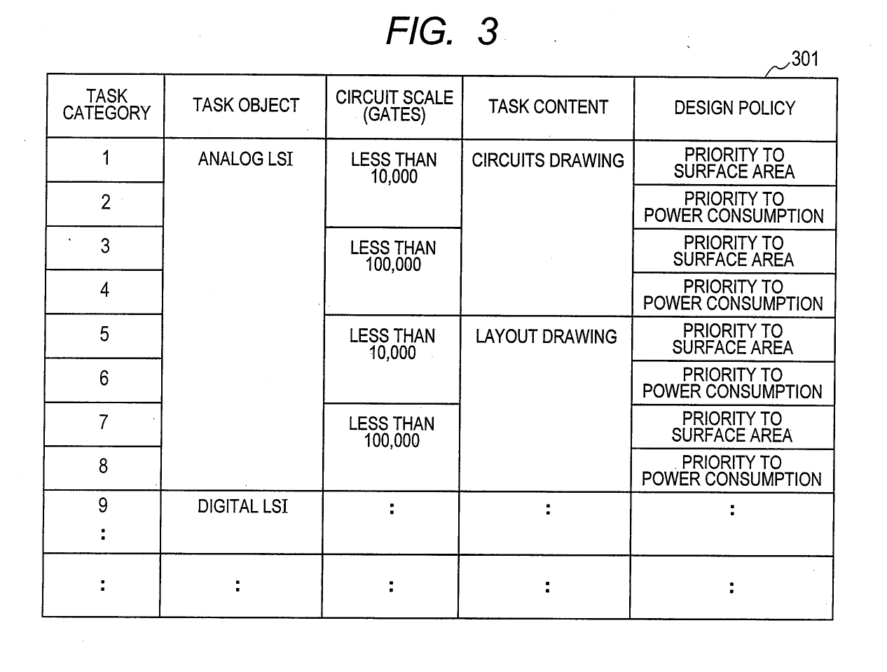

FIG. 3 shows one example of sorting task contents when performing tasks using the application software. The category 301 in FIG. 3 is a classification example assuming that design tools are the application software that performs LSI design tasks. The task categories within the category 301 are grouped into task objects, circuit scale (gates), and task content, and design policy.

The task objects in the case of a design tool for example are grouped based on the types of LSI devices for design such as analog LSI and digital LSI. The specific designs are grouped based on the circuit scale expressing the circuit size, the task contents based on what tasks are performed such as forming or forming the circuit and layout, and the design policy stressing items such as the surface area priority and power consumption priority during design work. The embodiment then groups the users based on which task in the task category the application software user is performing.

When grouping tasks, the extent to which the tasks are sub-grouped may be adjusted in cases such as where there are few users grouped into each task section. Moreover the present embodiment may be applied to one task as a whole without sub-grouping the task.

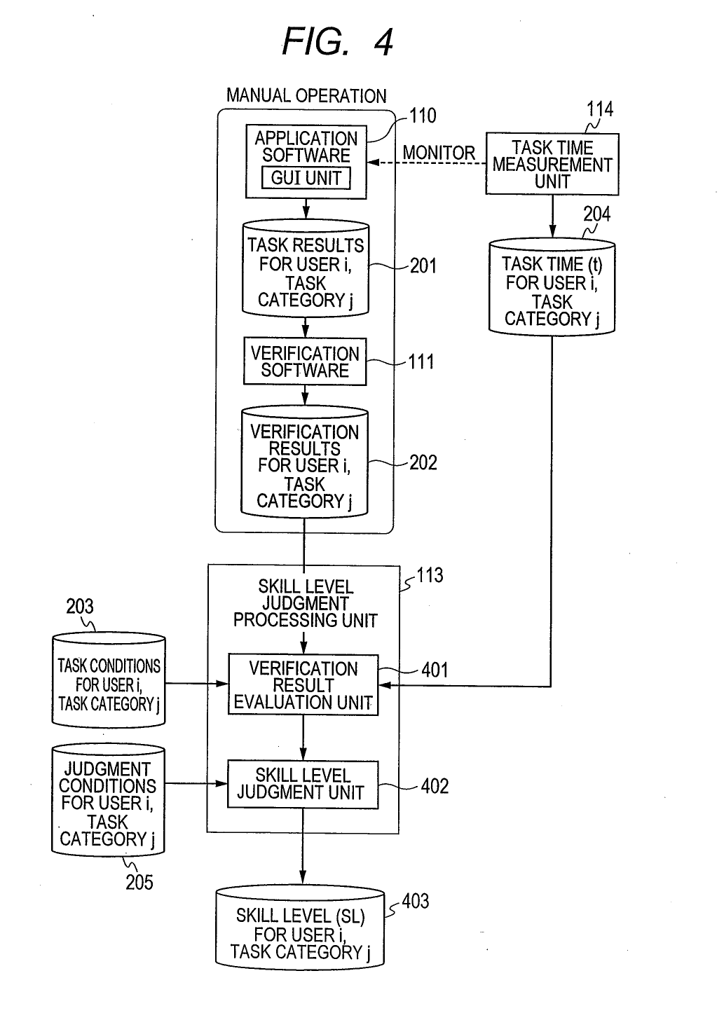

FIG. 4 is a drawing showing the detailed structure of the task skill level judgment processing unit 113 for the users in FIG. 1 and FIG. 2. FIG. 4 shows the skill level judgment processing implemented when the user i is using the application software on the task j of the task category shown in FIG. 3.

The reference numeral 110 in FIG. 4 denotes the object applications software for applying the GUI customizing method of the present embodiment. Results from tasks performed by the user interactively operating this software by way of the GUI are output as task results 201 as user i, task category j. The verification software 111 is utilized as a tool for verifying the performance of task result 201. The verification software 111 verifies the quality and performance of the task result 201, and outputs the results as the verification result 202.

During LSI design task for example, the circuit drawing tools and layout drawing tools are equivalent to the application software. Moreover, circuit simulation tools and physical verification tools are equivalent to verification software. If the application software is a circuit drawing tool, then the task results 201 are a net list containing constants for the circuit components and circuit connection relations that were drafted. The verification software 111 verifies the task results 201, estimates the circuit performance by way of circuit simulations and physical verification functions, and outputs the results as the verification results 202.

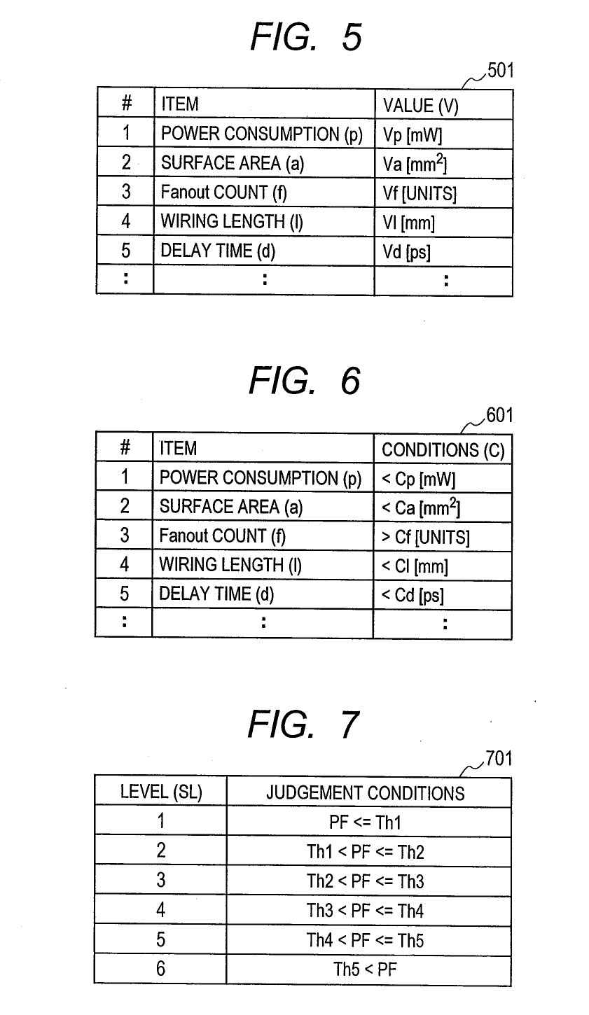

FIG. 5 shows one example of these verification results. The verification results 501 contains verification items such as the power consumption (p), the surface area (a), the fan-out count (f), the wiring length (l), and the delay time (d) of the prepared circuit. Verification result values for each item in the verification results 501 are respectively, Vp[mW], Va[mm²], Vf[elements], Vl[mm], Vd[ps]. Other diverse verification items may for example include the operating frequency, gain, transient response characteristics and so on according to the objective for fabricating the circuit, however these items are omitted to avoid complicating the description. The verification software is executed based on interactive operation by the user or batch processing by indicating the verification parameters

The task time measurement unit 114 in FIG. 4 measures the task time (t) 204 spent by the application software user when performing tasks using the application software. The task time measurement method for example sets the time that the application software starts up as the task start time, the time that the task results were output as a file as the task end time, and then calculates the time difference between the task start and task end times. The unit 114 can detect the application software task start time by utilizing the process monitor function prepared within the computer operating system. The unit 114 can detect the time that the task results are output by utilizing a function for monitoring the generation, update, and accessing of files prepared in the operating system. The unit 114 may detect the task end time for example as the time that the verification software accessed the task result file. The task time measurement accuracy can be improved by deducting the time that the application software occupies the CPU as idle time if below a specified time (period) from the task time.

The skill level judgment processing unit 113 of FIG. 4 evaluates the verification results in the verification result evaluation unit 401, based on verification results 202 for verification software 111, the task conditions 203, and the task time 204.

FIG. 6 shows one example of the task condition 203 as 601 during circuit design using the circuit drawing tool. In task condition 601 for example, the performance value tolerance ranges are established as the target values or the limiting conditions for the respective items in FIG. 5. The conditions set in the task condition 601 in FIG. 6 are that the power consumption (p), the surface area (a), the wiring length (l), and the delay time (d) are respectively less than Cp[mW], Ca[mm²], Cl[mm], Cd[ps] or that the fan-outcount (f) is greater than Cf (elements).

In FIG. 4, the verification result evaluation unit 401 calculates the performance PF=f(·) from the task time, task conditions, and performance values in the verification results based on the performance evaluation function f (p, a, f, l, d, . . . , t). The evaluation function f=(·) is expressed for example in the following formula 1.

$$f ( p , a , f , l , d , … , t ) = ( α p \times ( Cp - Vp ) / Cp + α a \times ( Ca - Va ) / Ca + α f \times Vf / Cf + α l \times ( Cl - V l ) / Cl + α d \times ( Cd - Vd ) / Cd + … ) \times T / t \qquad ( Formula 1 )$$

The α is here adjusted according to the priority level of each verification item based on the design policy. Moreover, T is set as the reference task time for each task category.

In FIG. 4, the skill level judgment unit 402 judges the performance of task results evaluated by the verification result evaluation unit 401 based on the pre-established judgment conditions 205, and judges the skill level (SL) 403 when the user i performed tasks in task category j. The task result 201, the verification result 202, the task conditions 203, the task time 204, the judgment condition 205, and the skill level 403 are respectively results in user i, category j, and are a subset of the task results 120, verification result 121, task conditions 122, task time 125, task conditions 123, and skill level 124 in FIG. 1.

FIG. 7 shows one example of the skill level judgment conditions 701. The performance PF value of the task results determines the user skill level (SL). The judgment processing unit for example, judges a PF value that is larger than the threshold Th2 and the same or lower than the Th3 as a skill level 3 for the application user who performed that task.

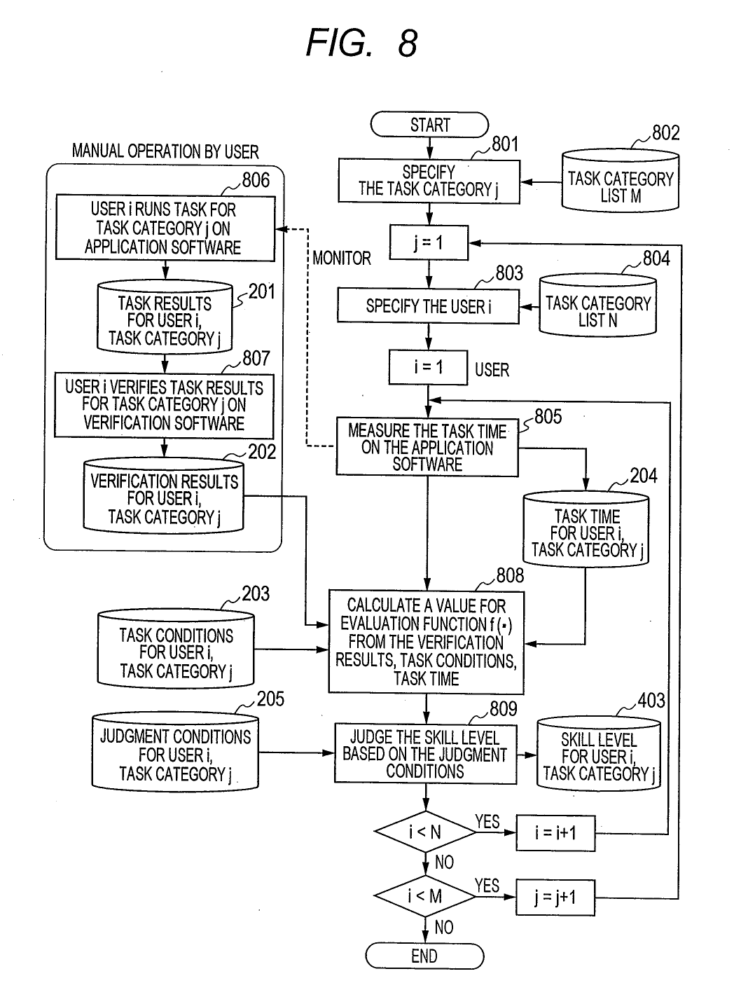

FIG. 8 shows the process flow for judging the skill level described above based on the structure in FIG. 4. First of all, when the skill level judgment processing unit 113 starts to operate, the task category list 802 specifies the task category j in 801 based on FIG. 3. The judgment processing unit then specifies a user i preregistered as the application software user from the users list. Next, the application software is monitored in 805 and when the user i has performed a task in task category j using the application software (806), the task time measurement unit 114 measures the user i task time using the method related in the description of the task time measurement unit 114. The judgment unit then stores the now measured task time 204 in the storage device in a format such as a file by task category or by user.

The ID entered by the user i when using the application software for example, specifies whether the user i is performing a task. The user i may give notification in advance or a method may be used for entering the task category number at the start of the task to specify that a task in task category j is being performed. A parameter set in the application software may also judge if a task is being performed. In 808, the judgment processing unit calculates the value of the evaluation function f(·) from the verification result 202, the task condition 203, the task time 204, obtained by a user verifying the task results of user i, task category j, on the verification software in 807 based on the results 201 from that task performed by the user in 806, and the judgment processing unit then evaluates performance from the task results. In 809, the judgment processing unit decides the skill level 403 by making a judgment for evaluating performance based on judgment conditions 205, and stores the skill level 403 in the storage device.

The judgment processing unit executes the processing flow in 801 through 809 on all registered users and registered task categories utilized in the GUI customizing process, and judges the skill levels for all user groups using the object application software.

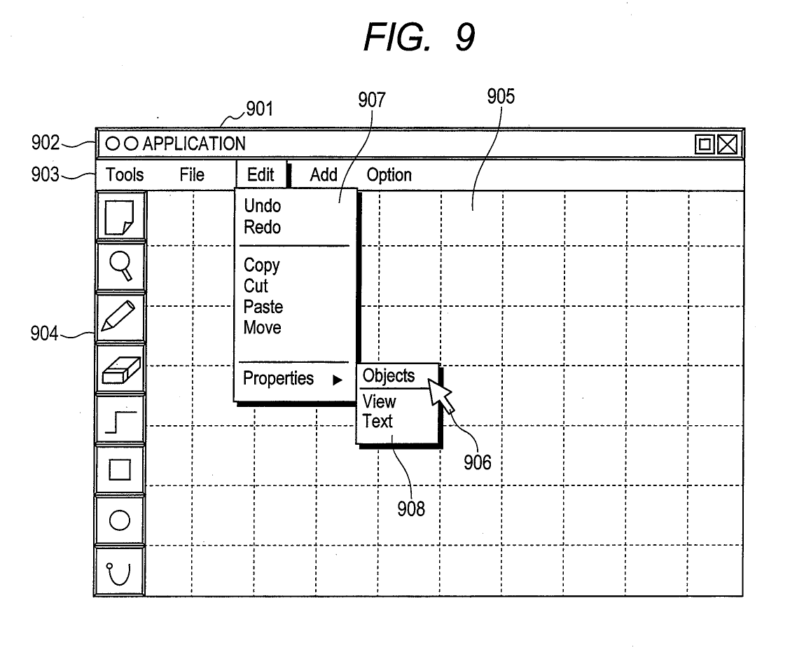

FIG. 9 is a drawing showing one example of the GUI screen for the application software serving as the application object of this embodiment.

On the display device connected to the computer in the example in FIG. 9, the application software GUI screen appears as one window of the window system serving as the GUI system on the computer. In the figure, 901 denotes the window displayed as the GUI screen of the application window. The 901 window includes an area 902 for displaying the title of the application software, an area 903 for displaying a menu serving as the GUI object, an area 904 for displaying the buttons, and a field 905 for displaying and editing for example images and letters, etc. Commands for operating the application software are normally assigned to GUI objects such as the menu and buttons. The user operates a pointing device such as a mouse to move the cursor 906, and execute application software commands by selecting a button or menu.

The example in FIG. 9 displays a state where the Edit menu 907 was opened, and the Properties item on that menu selected to open the hierarchically prepared submenu 908 and the Objects item then selected. Besides the method using a pointing device such as a mouse to move the cursor, methods for operating the GUI may include a method to assign the specified key directly to each GUI object and to select the GUI object by inputting that key from the keyboard.

Assuming for example that the application software is a LSI design tool, the design must then be performed by satisfying conditions in task categories whose object is analog circuit design such as RF circuit design. Such conditions would include performance conditions such as frequency characteristics, noise characteristics, gain (loss), power, and delay time and mounting conditions such as the chip surface area and power consumption. Moreover, task conditions such as target values and limiting conditions must be set after taking into account effects from process variations and parasitic elements such as wiring capacitance and wiring resistance. In order to design a circuit that satisfies the task conditions, parameters must be set not only for circuit element constants but also for the various physical characteristics. In order to assign functions for setting these parameters, the LSI design tool normally includes multiple GUI objects such as menu items, buttons, and text input boxes. These setting items may span many areas but in actual use most parameters can be set as default values without causing problems by taking into account the design policy and target values that should be set. However, actually finding and selecting the required item according to the user's skill level from the many GUI objects is difficult. In such cases, the GUI object matching the item that must be set can be enhanced and unnecessary GUI objects can be hidden on the display, or customizing performed to render some objects non-selectable to alleviate user confusion and user mistakes, to make GUI operation more efficient.

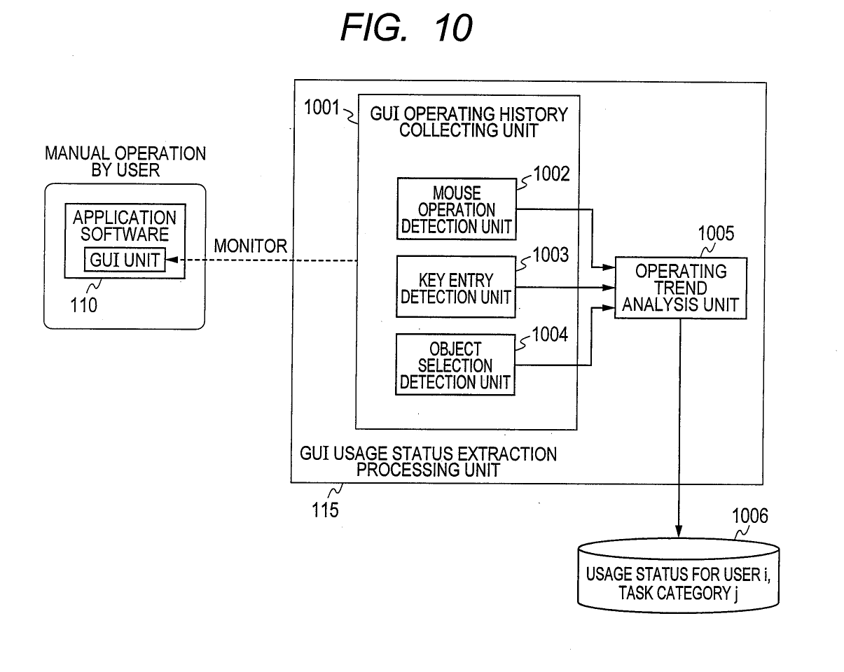

FIG. 10 is a block diagram showing the structure of the GUI usage status extraction processing unit 115 in FIG. 2, for extracting the GUI usage status of the application software user. The GUI usage status extraction processing unit 115 accumulates the history from operating the GUI of application software 110 serving as the application object of this embodiment, into the GUI operating history collecting unit 1001 in order for the user i to perform tasks in task category j. The GUI operating history collecting unit utilizes the GUI object display and the GUI information monitor function for controlling the input devices, in order to monitor GUI object display commands issued by the application software or operating commands for the application software to acquire information about operation such as selections of GUI objects by input devices such as keyboards or the mouse, and then accumulates that history by detecting those contents. The GUI information monitor function is already available for development use on typical window systems.

The GUI operating history collecting unit 1001 contains a mouse operation detection unit 1002, a key entry detection unit 1003, and an object selection detection unit 1004. The GUI operating history collecting unit 1001 accumulates information detected by each of the above components as histories. The mouse operation detection unit 1002 detects the movement of the mouse cursor by the user on the GUI object, and operations such as object selection (single click), object execution (double-click), etc. The key entry detection unit 1003 detects key information that the user entered from the keyboard. The object selection detection unit 1004 detects the selection or execution of the GUI object by key input or mouse operation.

The operating trend analysis unit 1005 analyzes the GUI operating trends such as by what type of operation the user executed the application function linked to the GUI object based on the GUI operating history that the GUI operating history collecting unit 1001 collected. The operating trend analysis unit 1005 then outputs the usage status 1006 for user i, task category j based on this analysis. The usage status 1006 is a subset of usage status 126 in FIG. 1.

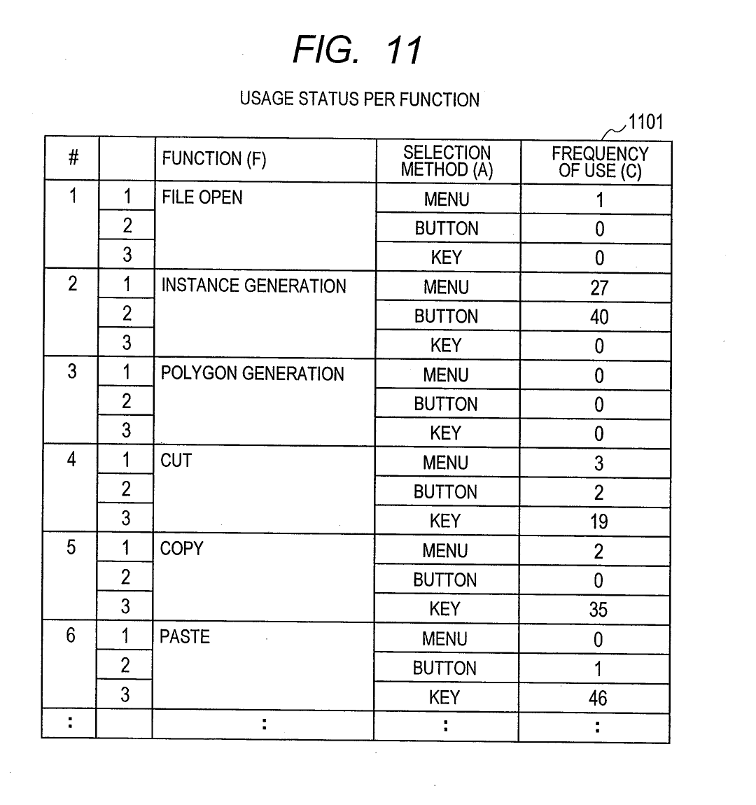

The numeral 1101 in FIG. 11 is an example of the usage status 1006 for each function in user i, task category j in FIG. 10. Here, the operating trend analysis unit 1005 determines the usage status by measuring the frequency that the user utilized, a key (keyboard) input or the frequency the user utilized a mouse to select an object such as a menu or a button in order to execute the functions of application software for the corresponding GUI object during the time the task was performed.

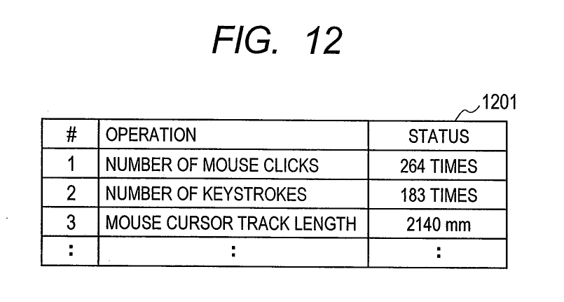

In FIG. 12, numeral 1201 is another example of the usage status 1006. In FIG. 12, the operating trend analysis unit 1005 determines the usage status by measuring the number of mouse clicks, the number of key strokes, and length of the mouse cursor track.

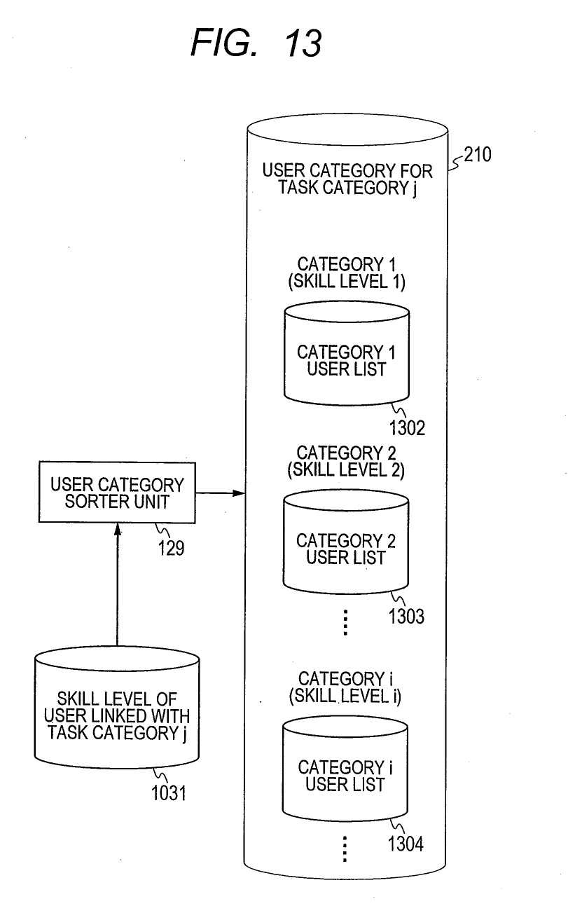

FIG. 13 is a drawing for describing the processing by the user category sorter unit 129 in FIG. 2. Based on the user skill level in 1301, the user category sorter unit 129 sorts all users belonging to task category j with skill level ranks (1, 2, . . . i, . . . ) into respective categories such as the user group of skill level 1 as category 1, the user group of skill level 2 as category 2, . . . the user group of skill level i as category i. The user category sorter unit 129 then makes the lists 1302 through 1304 for users in each category as the user category 210 for the task category j. The description in FIG. 13 utilized tasks for task category j as an example but in actual use the above processing is executed for all task categories.

Besides the above described method, other methods for category sorting may include further grouping even of users in the same skill level by different conditions such as user attributes (association, task experience, etc.) or by hardware restrictions on the user terminal, etc. Conversely, the sorter unit can group all users into a single category without sorting user groups belonging to task category j. The method of the invention in that case customizes the GUI according to the task category regardless of the skill level.

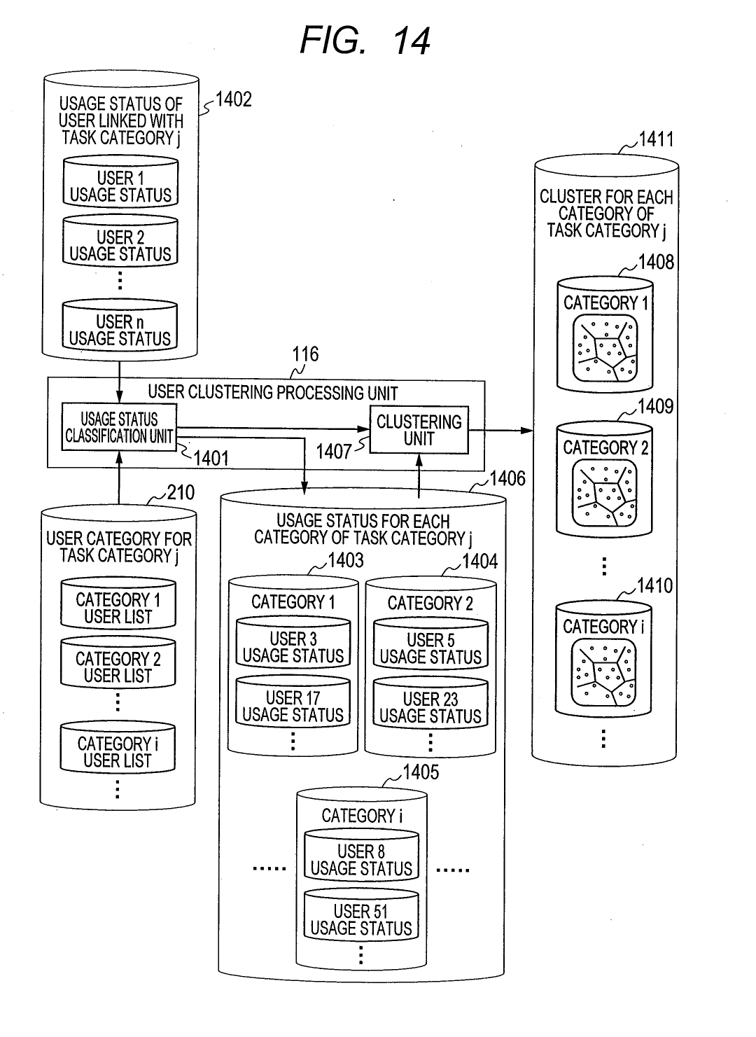

FIG. 14 is a drawing for describing the processing by the user clustering processing unit 116 in FIG. 2. Here also, the description utilizes the processing flow for task category j as an example but in actual use this processing is executed for all task categories. In the example in the figure, the usage status classification unit 1401 groups the usage status of the user into categories from the user category 210 of task category j grouped by the user category sorter unit 129, and from the usage status of users linked with task category j 1402 (also called usage status data 1402). The usage status data 1402 for all users 1-n performing tasks in task category j 1402 is grouped into the multiple categories 1403, 1404, 1405 . . . , and so on (usage status 1406 for each category of task category j) based on the user list for each category in user category 210. The usage status data 1402 is a subset of the user usage status 126 in FIG. 1. In this example, the users belonging to category 1 were set as 3, 17, and the users belonging to category 2 were set as 5, 23, . . . , and the users belonging to category i were set as 8, 51, . . . but this arrangement is only an imaginary example intended to make the description easy to understand.

The clustering unit 1407 clusters users into multiple clusters 1408, 1409, 1410, . . . (cluster 1411 for each category of task category j) based on the degree of similarity in the usage status corresponding to each of the task category j usage status 1406.

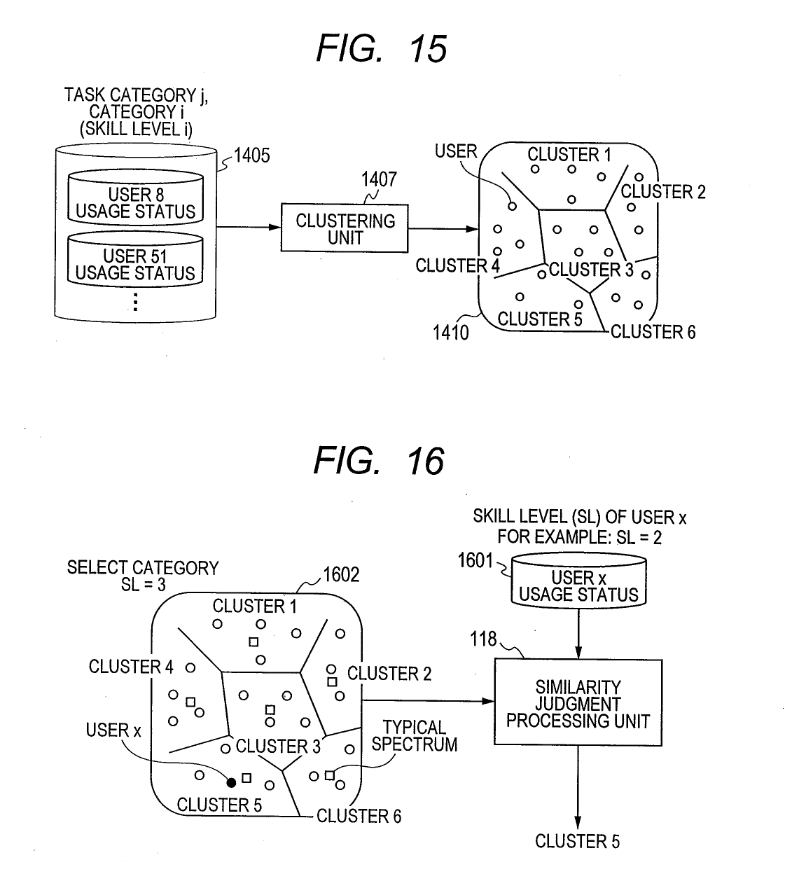

FIG. 15 is a drawing for describing the processing by the clustering unit 1407 in FIG. 14. The figure shows an example of the clustering unit clustering category i usage states. In the clustering unit expresses for example the usage state of user k as the feature vector Vk in the following Formula 2. Vk=(CF1k, AF1k, CF2k, AF2k, CF3k, AF3k, . . . ) . . . (Formula 12) CFlk: Frequency of use in function Fl of user k(l=1, 2, . . . ) AFlk: Selection method of function Fl of user k (l=1, 2, . . . )

(Menu: 1, Button: 2, Key: 3)

Based on the degree of similarity among all users, the clustering unit performs clustering of each user using feature vectors (of all users), and for example the k-means technique as the clustering method. However, if the vector dimension is large, then the number of dimensions may be reduced by selecting analysis methods such as principle component analysis, or selecting only functions and methods with high frequencies for vector elements. In the example in FIG. 15, the clustering unit 1407 uses clustering to group the user group into six clusters.

The examples in FIG. 14 and FIG. 15 described clustering the users in each category based on degree of similarity in usage status and separating the users into multiple clusters. In some cases however, the number of clusters can be set to 1, or in other words essentially no clustering performed. This method may be used in cases where there are few users belonging to a category or when the usage status of all users belonging to that category meets conditions such as the degree of similarity. In those cases, the following processing can be executed with the number of clusters equaling 1.

FIG. 16 is a drawing for describing the processing performed by the similarity judgment processing unit 118 in FIG. 2. The similarity judgment processing unit 118 judges which cluster in the selected category that the user x belongs to, by judging the degree of similarity in feature vectors expressing usage status, for the cluster 1602 in the selected category versus the usage status 1601 of user x who is the GUI customizing target.

In the example in FIG. 16, the similarity judgment processing unit 118 selects the skill level SL=3 category for user x skill level SL=2 for the task in task category j, judges the degree of similarity and selects the cluster 5 as the cluster to which the user x belongs. One method for judging the degree of similarity is for example to calculate the distance between the typical vector for each cluster, and the feature vector of user x; and set the cluster associated with the nearest (shortest distance) typical vector as the usage status cluster nearest the usage state of user x. The vector closest to the center or the average vector with elements belonging to each cluster is utilized as the typical vector.

Selecting the skill level SL=3 category for a user at skill level SL=2 allows following the GUI operation of a user with a higher skill level by operating the GUI near that usage state. The consequent result that can then be expected is an improvement in the operating efficiency and skill level of user x.

Besides the above method, another method for judging the degree of similarity is to select a cluster other than the cluster with the highest degree of similarity. A GUI can in this way be selected that is different from the GUI operating trends used by the user x up until now, so one can anticipate that user x will show improved results in mastering new GUI operating methods. The same skill level should be selected in these cases.

After customizing the GUI based on the cluster selected in the above processing, the cluster selection method and method for judging the degree of similarity can be changed if a skill level judgment made after the user performs a specified number of tasks does not exhibit any effects from customizing the GUI. Moreover, if the skill level has been raised then the GUI can be customized to a higher level according to the improvement in user skill by periodically changing the GUI customizing in the above process such as by making similarity judgments targeting a category at a one step higher skill level and then customizing a new GUI. The timing for judging the skill level may be at the point in time the task was completed, or verification results may be evaluated at steps during the task, and the shape of the performance improvement curve for task results then utilized to improve the skill level judgment accuracy.

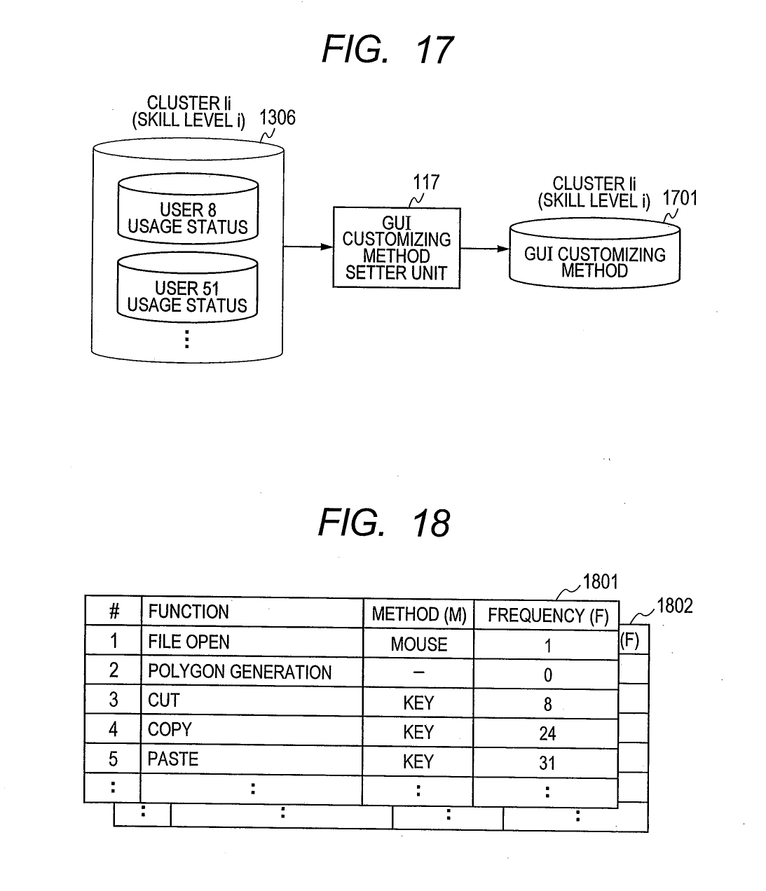

FIG. 17 is a drawing for describing the processing by the GUI customizing method setter unit 117 in FIG. 2. The GUI customizing method setter unit 117 sets the GUI customizing method based on the GUI usage status for each user group cluster. In the example in FIG. 17, the GUI customizing method setter unit 117 sets the GUI customizing method 1701 from the usage status for usage status 1306 of cluster i in the task category j as shown in FIG. 13.

FIG. 18 is a table showing the usage status content of the user group belonging to cluster i in FIG. 17. This table sums the functions matching the GUI object, and the method that selected the GUI object between task times, and the frequency of occurrence for each user. In the example in FIG. 18, the numeral 1801 shows the usage status of the user 8, and 1802 shows the usage state of the user 51.

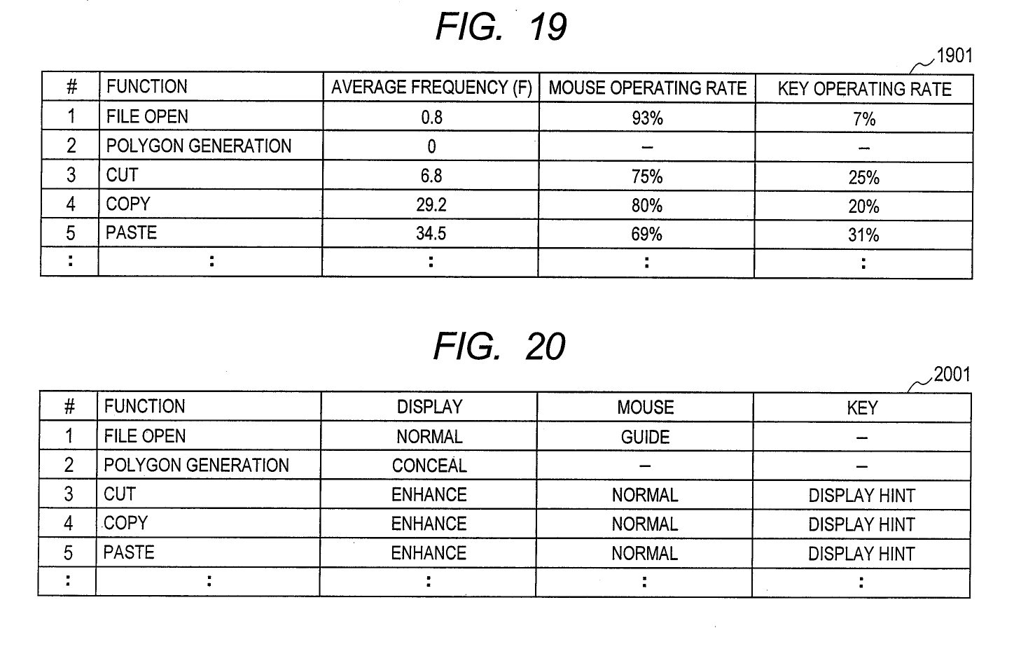

The numeral 1901 in FIG. 19 shows results from calculating the cluster i usage state from the usage status list in FIG. 18. This table calculates the average selection frequency, selection method and rate that the mouse was operated, and the rate that the key was operated for each function in the user group belonging to cluster i.

The numeral 2001 in FIG. 20 shows an example for setting the GUI customizing method based on the usage status of cluster i in FIG. 19. Here, the method for customizing each GUI object is set based on rules so that for example, an average frequency below 0.3 hides that object, and average frequency below 20.0 displays the object normally, and an average frequency of 20.0 or higher enhances the display based on the average frequency in FIG. 19.

The hide method may for example not show the display, may gray-out the display, or may make the display non-selectable. The enhancing method may for example make bold (thick, black) letters, a flashing display, a large size or set a higher display position, etc.

The mouse cursor can be made easy to guide and select in functions where there is a high mouse operating rate, and conversely made difficult to select in functions with a low operating rate, etc. Also, in functions with a high key operating rate, a balloon display can for example be shown as a hint with information on the corresponding key.

The customizing method in the above example was set automatically based on the usage status. However, the customizing method may also be set heuristically for each category and each cluster, based on the attributes of the user and usage status, and hardware restrictions on the user terminal.

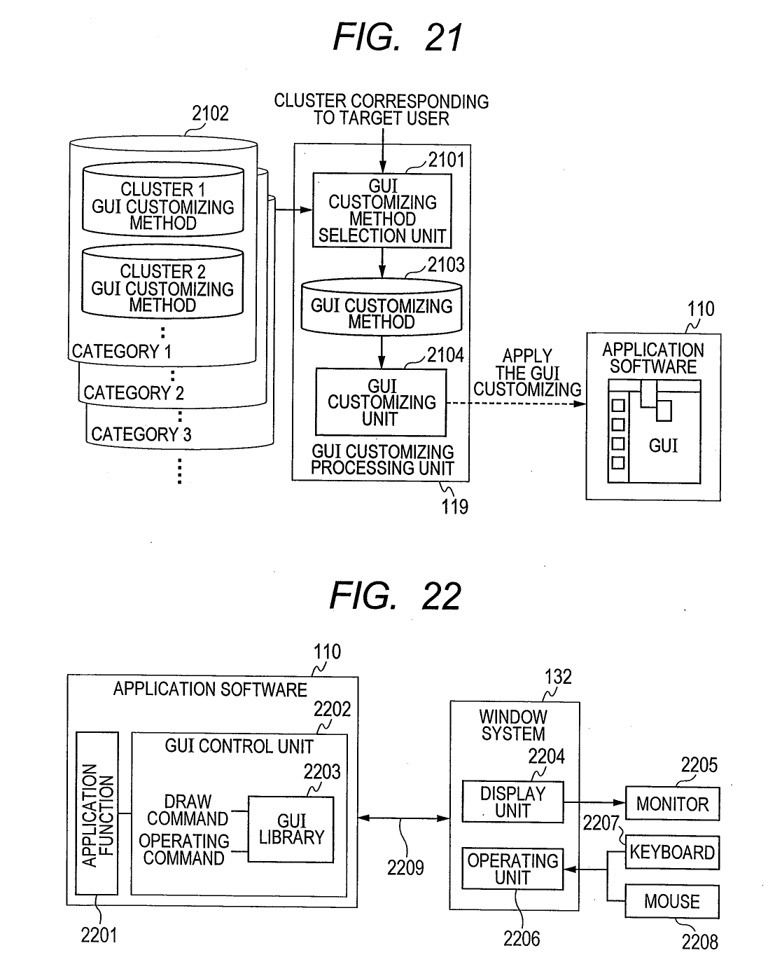

FIG. 21 is a diagram for describing the processing by the GUI customizing method selection unit 2101 in FIG. 1 and FIG. 2. The GUI customizing processing unit 119 selects the GUI customizing method 2103 for the applicable cluster from the GUI customizing method 2102 based on the cluster and the category in which the user targeted for GUI customizing belongs and that were linked by the similarity judgment processing unit 118 described in FIG. 16.

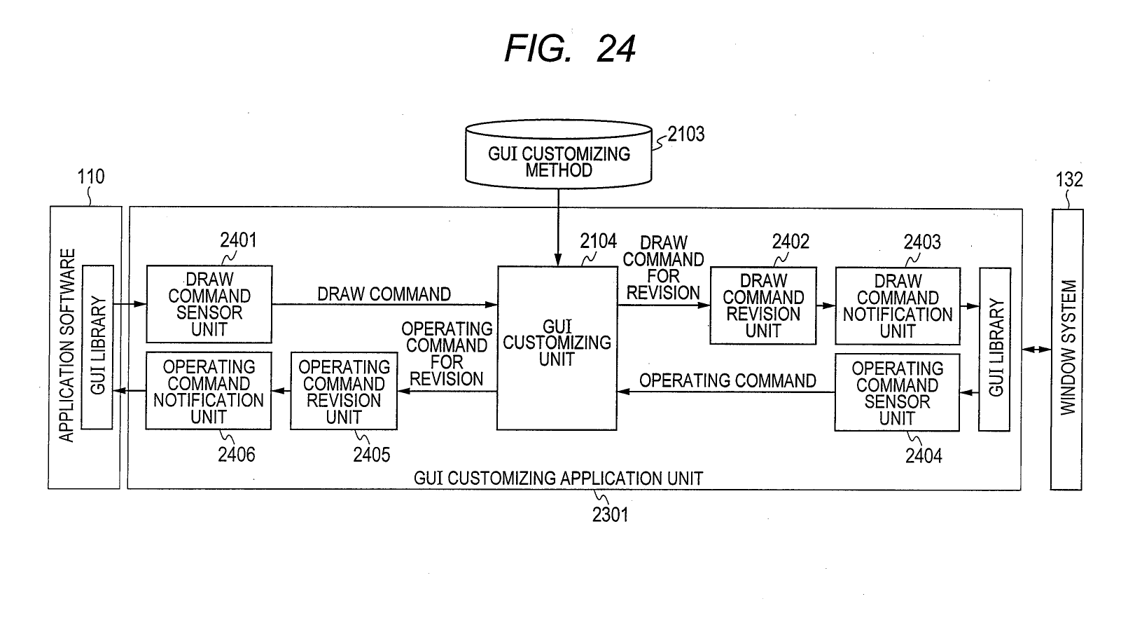

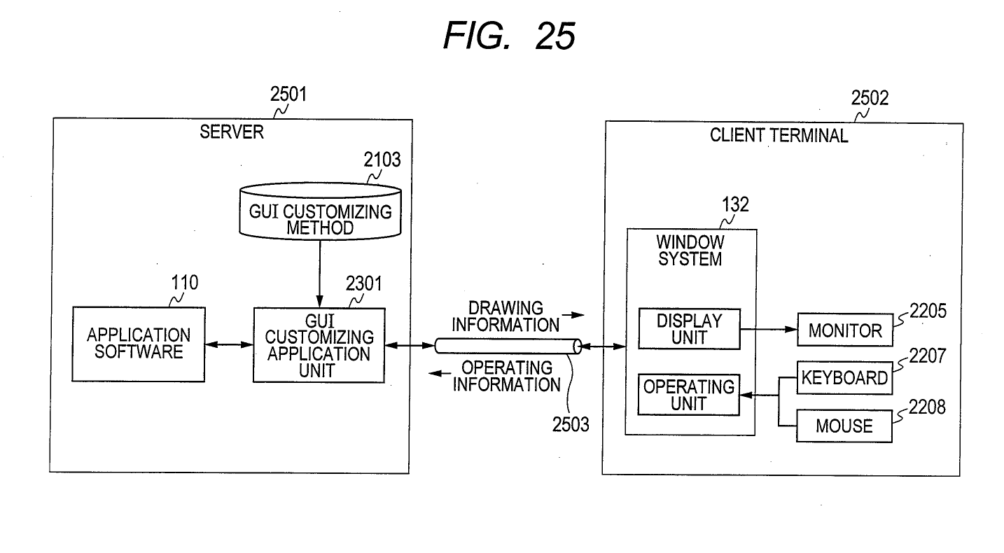

The GUI customizing unit 2104 customizes the GUI by applying the selected GUI customizing method 2103 to the GUI of the application software 110. The method for applying the GUI customizing method to the application software GUI is described in detail, for the GUI customizing application unit in FIG. 24 and so in not described in the drawings here.

The processing for controlling and displaying the GUI of this embodiment on an information processing system such as a computer is described next while referring to FIG. 22 through FIG. 24.

The computer containing the GUI system generally includes a window system for controlling the operation and display of the GUI on the operating system. The application system containing the GUI is generally displayed on the monitor of the display device serving as the window on the window system. While viewing the monitor, the user selects or executes objects or controls the cursor using a mouse, or may operate the GUI object application software by using a keyboard.

In FIG. 22, the application software 110 for the computer system including the GUI system contains an application function 2201 for performing the target task, and a GUI control unit 2202 for controlling the GUI. The GUI control unit 2202 draws pictures on the window system 132 screen and acquires the user GUI operating information by way of a path 2209 shown diagrammatically to allow the user to interactively access the application functions.

The GUI control unit 2202 executes GUI operating information or drawing requests for the application by exchanging operating commands and drawing command with the window system 132. The application software 110 summons (calls up) the library 2203 prepared in the window system 132 to convey drawing commands and operating commands from the GUI control unit 2202 to the window system 132. The window system 132 displays the drawing information in the application software to the monitor 2205 by way of the display unit 2204. The window system 132 conveys the operating information input by the operating unit 2206 using the keyboard 2207 and/or mouse 2208 to the application software.

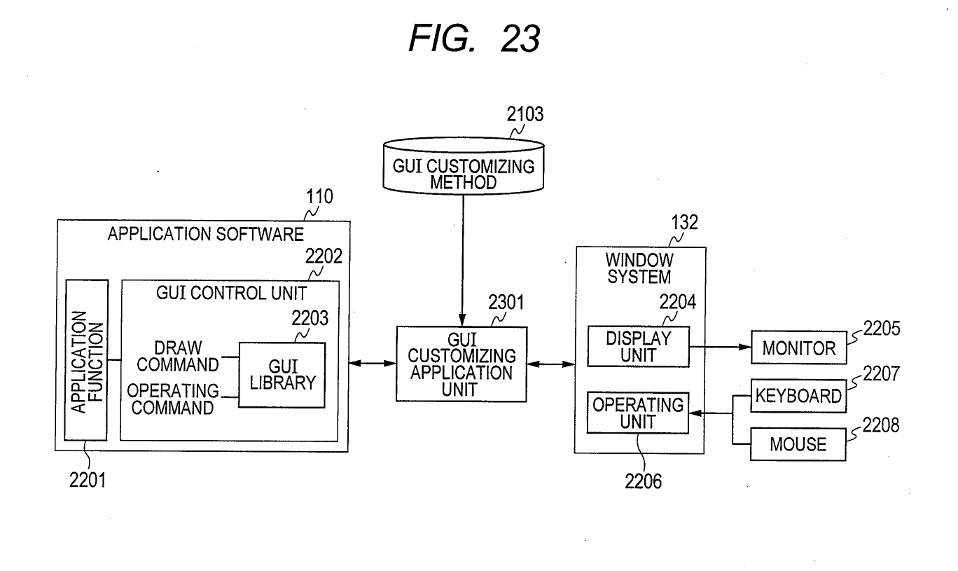

FIG. 23 is a diagram for diagrammatically describing the method for customizing the GUI of the application software 110 of this embodiment on the computer system structured as shown in FIG. 22. In FIG. 23, when the application software 110 has called up the GUI library 2203, the GUI customizing application unit 2301 including the above described GUI customizing unit 2104 serving as the program on the operating system, detects the GUI library 2203 call-up, acquires the GUI library called up instead of the window system 132, and after customizing based on the GUI customizing method 2103, conveys the post-customization GUI library information to the window system 132.

The window system 132 displays the customized drawing information on the monitor 2205. Before the keyboard 2207 and mouse 2206 operating information acquired by the window system 132 is conveyed to the application software 110, the GUI customizing application unit 2301 acquires that information and conveys it to the application software after customizing the GUI based on the GUI customizing method 2103. The GUI customizing application unit 2301 accumulates the drawing commands and operating commands called up to display the GUI object and control the input devices by detecting that information by way of a function that monitors the call-up of the GUI library 2203. A function to monitor the call-up of the GUI library 2203 is prepared beforehand for development work on a typical window system. The functions of the GUI customizing application unit 2301 may be installed in the GUI control unit 2202 of application software 110 if the application software 110 can be directly modified.

FIG. 24 is a diagram showing an example of the structure of the GUI customizing application unit 2301 shown in FIG. 23. The draw command detection unit 2401 acquires the drawing command sent by the application software 110 calling up the GUI library, and sends the drawing commands to the GUI customizing unit 2104 within the GUI customizing application unit 2301. The GUI customizing unit 2104 judges whether the detected drawing information command is the drawing command targeted for customizing based on the GUI customizing method 2103, and if the target customizing information, customizes it in the draw command revision unit 2402. The draw command notification unit 2403 calls up the GUI library based on the customized drawing command and gives notification to the window system 132.

The operating command detection unit 2404 acquires the user operating information that the window system 132 acquired, and sends that information to the GUI customizing unit 2104. The GUI customizing unit 2104 judges based on the GUI customizing method 2103 whether the detected operating commands are operating commands targeted for customizing, and if operating commands targeted for customizing, customizes those commands in the operating command revision unit 2405. The operating command notification unit 2406 notifies the application software about the customized operating command.

In the systems in FIG. 1 and FIG. 22-FIG. 24 described as the information processing system in the first embodiment, the application Software, window system, and GUI customizing program are all in the same information processing device and are examples of the case where the display device and input devices such as the keyboard and mouse are connected to the information processing device.

### Second Embodiment

Information processing systems may also include server-client configurations in which an application is installed on a server, and a client terminal starts up the application software, the application software image information appears on the client terminal display device, and the user operates the application software by utilizing a user interface such as a keyboard or mouse connected to the client terminal. In this case, data communication such as drawing information and operating information is carried out between the server and client terminals over a communication network. In this type of configuration, the server side can manage the application software so there is no need to install the application software in each user terminal. The server functions can also be installed at an external (remote) datacenter in a service configuration called an ASP (Application Service Provider) or SaaS (Software as a Service) in which the user accesses the datacenter from the client terminal to use the application. The present invention can also be used on these types of information processing systems.

The GUI customizing method for server-client type information processing systems in the second embodiment is described next while referring to FIG. 25. In the information processing system in FIG. 25, the application software 110, the GUI customizing method 2103, and the GUI customizing application unit 2301 are mounted on the server 2501 side, and the customized drawing information is sent by way of the communication network 2503 to the window system 132 of client terminal 2502. The mouse 2208 and keyboard 2207 operating information on the client terminal 2502 is sent to the server, and the server is notified of the customized application.

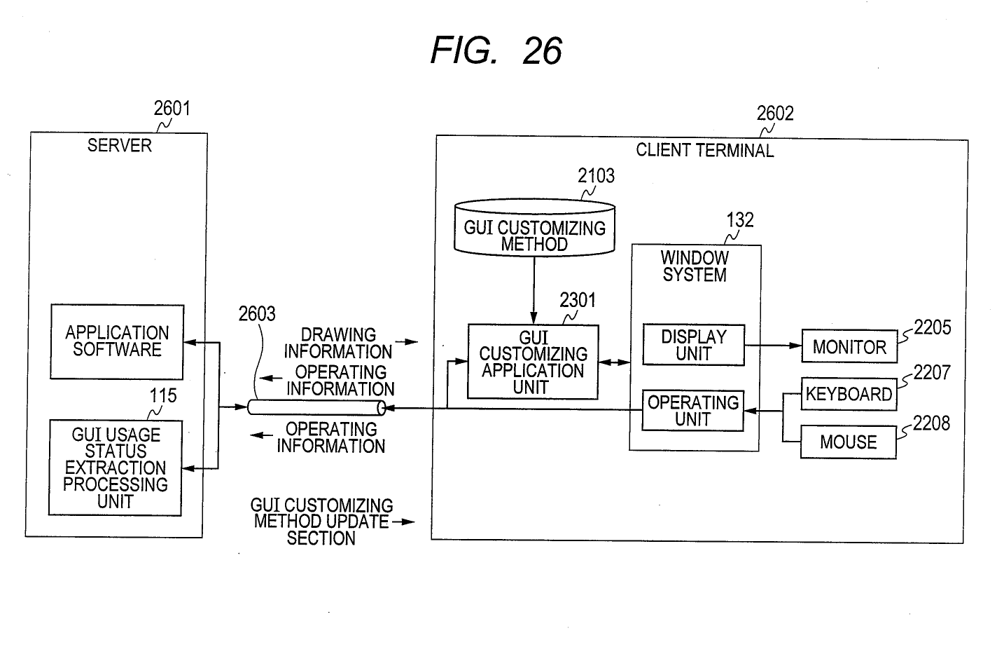

In another adaptation of the information processing system of the second embodiment as shown in FIG. 26, the GUI customizing method 2103, and the GUI customizing application unit 2301 are mounted on client terminal 2602, and the customizing processing may be performed on the client terminal side. In this case, the server 2601 sends drawing information over the communication network 2603 to the client terminal and customizing is performed on the client terminal side. The client terminal sends the customized operating information to the server 2601 and notifies the application software. Also, the client terminal sends operating information such as the pre-customizing mouse operation and key operation to the server, and the GUI usage status extraction processing unit 115 mounted in the server accumulates the operating information sent from the client terminal and extracts the usage status of the user. If the GUI customizing method has been updated due to a change in the usage status, or if the task category has changed due to a change in the user task, then the server sends an updated GUI customizing method to the client terminal.

Utilizing the various methods described in the above embodiments allows customizing the GUI of the application software according to the skill level and usage status of the user. In the above descriptions, verification software was utilized as the method for verifying the task results that used the application software. Other methods however, may include for example methods where expert users evaluate the task results, or methods where the task results are displayed over the Internet and evaluation is performed by the number of queries or by popular vote, etc. In cases in particular where making a quantitative verification is difficult due to the judgment scale such as where judging the artistic quality of task results on application software that for example is editing software such as video, audio or image software; then results obtained by human resources over these type of networks can be utilized as verification results.

This invention relates to a GUI technology for application software operating on an information processing system of a computer, and in particular is effective as a technology for customizing GUI according to the task status and the skill level of the user.

1. A GUI customizing method for information processing systems including a processing unit to execute software containing a graphical user interface (GUI), the method comprising:
the processing unit extracting the usage status of the user from the software operating history;
the processing unit clustering the multiple software users into clusters based on the degree of similarity in usage status;
the processing unit changing the software GUI based on the usage status representing each of the multiple clusters sub-grouping the multiple users based on clustering results;
the processing unit grouping the specified user into any of the multiple clusters by comparing the usage status representing each cluster, with the usage status of the specified user; and
the processing unit changes the software GUI of the specified user based on the GUI of the cluster in which the specified user is sub-grouped.

2. The GUI customizing method of claim 1, further comprising:
the processing unit grouping the multiple software users into multiple categories based on specified conditions for the task utilizing the software; and
the processing unit performing clustering of the multiple users in each of the grouped multiple categories.

3. The GUI customizing method according to claim 1, further comprising:
the processing unit utilizing the skill level judged from the quality of results and required time of the user utilizing the software as the specified conditions.

4. The GUI customizing method according to claim 2, further comprising:
the processing unit grouping tasks utilizing the software into multiple task categories grouped by the attributes of the target task; and
the processing unit grouping the multiple software users into multiple categories.

5. The GUI customizing method according to claim 3, further comprising:
the processing unit verifying the results from the user utilizing the software;
the processing unit judging the skill level by comparing the task target values with the verification results, and
the processing unit linking the user to the category including a skill level that is specifically related to the judged skill level.

6. The GUI customizing method according to claim 5, further comprising: the processing unit linking to the specifically related category containing a skill level that is at least one step higher than the user skill level.

7. An information processing system including a storage unit and a processing unit to execute software containing a GUI, wherein the processing unit:
extracts the usage status of the user from the software operating history,
clusters the multiple software users into clusters based on the degree of similarity in usage status,
adjusts and stores the software GUI into a storage unit based on the usage status representing each of the multiple clusters sub-grouping the multiple users based on clustering results,
groups the specified user into any of the multiple clusters by comparing the usage status representing each cluster, with the usage status of the specified user, and
changes the software GUI of the specified user based on the GUI in which the specified user is sub-grouped.

8. The information processing system according to claim 7, wherein the processing unit:
groups the multiple software users into multiple categories based on specified conditions for the task utilizing the software, and
performs clustering of the multiple users grouped into each of the multiple categories.

9. The information processing system according to claim 8, wherein the processing unit utilizes the skill level judged from the quality of results and required time of the user utilizing the software as the specified conditions.

10. The information processing system according to claim 8, wherein the processing unit:
groups tasks utilizing the software into the multiple task categories grouped by the attributes of the target task and,
groups the multiple software users into multiple categories.

11. The information processing system according to claim 9, wherein the processing unit:
verifies the results from the user utilizing the software,
judges the skill level by comparing the task target values with the verification results, and links the user to the category including a skill level that is specifically related to the judged skill level.

12. The information processing system according to claim 11, wherein the processing unit links to the specifically related category containing a skill level that is at least one step higher than the user skill level.

13. The information processing system according to claim 7, comprising a server device including a storage unit and a processing unit connected to a client terminal by way of a network,
wherein the client terminal contains a window system and controls the window system over a network based on the software GUI changed for the specified user.

14. A computer readable medium storing a program executed by a processing unit in an information processing system including a storage unit and a processing unit to execute software having a GUI,
wherein the processing unit:
extracts the usage status of the user from the software operating history,
clusters the multiple software users into clusters based on the degree of similarity in usage status,
adjusts and stores the software GUI into a storage unit based on the usage status representing each of the multiple clusters sub-grouping the multiple users based on clustering results,
groups the specified user into any of the multiple clusters by comparing the usage status representing each cluster, with the usage status of the specified user, and
changes the software GUI of the specified user based on the GUI of the cluster in which the specified user is sub-grouped.

15. The computer readable medium storing the program according to claim 14, wherein the processing unit:
groups the multiple software users into multiple categories based on specified conditions for the task utilizing the software, and
performs clustering of the multiple users grouped into each of the multiple categories.

16. The computer readable medium storing the program according to claim 15, wherein the processing unit utilizes the skill level judged from the quality of results and the required time of the user utilizing the software as the specified conditions.

17. The computer readable medium storing the program according to claim 15, wherein the processing unit:
groups tasks utilizing the software into the multiple task categories grouped by the attributes of the target task, and
groups the multiple software users into multiple categories.

18. The computer readable medium storing the program according to claim 17, wherein the processing unit:
verifies the results from the user utilizing the software,
judges the skill level by comparing the task target values with the verification results, and
operates to link the user to the specifically related category including a skill level that is the judged skill level.

19. The computer readable medium storing the program according to claim 18, wherein the processing unit operates to link to a specifically related category different from the category matching the user skill level.
